(19) United States
(12) Patent Application Publication
(10) Pub. No.: US 2017/0167148 A1
(43) Pub. Date: Jun. 15, 2017

(54) CONSTRUCTION SYSTEM

(71) Applicant: Caterpillar Inc., Peoria, IL (US)

(72) Inventor: Tazio S. Grivetti, Chillcothe, IL (US)

(73) Assignee: Caterpillar Inc., Peoria, IL (US)

(21) Appl. No.: 14/964,729

(22) Filed: Dec. 10, 2015

(51) Int. Cl. E04G 21/04; B05B 13/00

(52) U.S. Cl. CPC E04G 21/0436; B05B 13/005

(57) ABSTRACT

A construction system is provided. The construction system includes at least one machine having a linkage assembly, a work implement, and a roof. The construction system also includes a gantry system having a beam member. The beam member is supported at a first end by the linkage assembly of the at least one machine, the work implement of the at least one machine, or the roof of the at least one machine.

### TECHNICAL FIELD

The present disclosure relates to a construction system, and more particularly to a construction system and a method of operating the construction system.

### BACKGROUND

A gantry system is used for constructing structures such as buildings, towers, etc. The gantry system includes a pair of rails, a beam member, and a dispensing system. The beam member extends between the pair of rails. The dispensing system is movable along a length of the beam member. The gantry systems that are currently available are bulky, and time consuming to set up and operate. Further, the gantry systems require skilled personnel for setting up and operating the gantry system, which may incur significant cost. In some situations, a structure built using the gantry system may be inconsistent due to involvement of various personnel during construction stages.

U.S. Pat. No. 7,814,937 describes a deployable crafting machine. The deployable crafting machine may include a vehicle and a gantry system. The gantry system may be configured to be collapsed on the vehicle during which the gantry system is inoperable, and to be expanded during which the gantry system is operable and supported at least in part by the vehicle. A deployable crafting process may include moving a vehicle to a first location while a gantry system is stored on the vehicle in a collapsed and inoperable state and expanding the gantry system into an operable state after the vehicle arrives at the first location during which the gantry system is supported at least in part by the vehicle.

### SUMMARY OF THE DISCLOSURE

In one aspect of the present disclosure, a construction system is provided. The construction system includes at least one machine having a linkage assembly, a work implement, and a roof. The construction system also includes a gantry system having a beam member. The beam member is supported at a first end by the linkage assembly of the at least one machine, the work implement of the at least one machine, or the roof of the at least one machine.

In another aspect of the present disclosure, a method of operating a construction system is provided. The construction system includes at least one machine and a gantry system. The at least one machine includes a linkage assembly, a work implement, and a roof. The method includes supporting a first end of a beam member of the gantry system on the linkage assembly of the at least one machine, the work implement of the at least one machine, or the roof of the at least one machine. The method also includes controlling a movement of at least one of the beam member of the gantry system and a dispensing system of the gantry system. The method further includes positioning at least one of the beam member of the gantry system and the dispensing system of the gantry system at a desired position, based on the control.

In yet another aspect of the present disclosure, a construction system is provided. The construction system includes at least one machine having a linkage assembly, a work implement, and a roof. The construction system also includes a gantry system. The gantry system includes a beam member supported at a first end by the linkage assembly of the at least one machine, the work implement of the at least one machine, or the roof of the at least one machine. The gantry system also includes a dispensing system configured to dispense construction material. The dispensing system is coupled to the beam member of the gantry system and is configured to move along a length of the beam member.

Other features and aspects of this disclosure will be apparent from the following description and the accompanying drawings.

### BRIEF DESCRIPTION OF THE DRAWINGS

FIG. 1 is a perspective view of a construction system having a machine and an A-frame support, according to one embodiment of the present disclosure;

FIG. 2 is a perspective view of the construction system having a first machine and a second machine, according to another embodiment of the present disclosure;

FIG. 3 is a perspective view of a portion of the construction system illustrating a first coupler of the construction system;

FIGS. 4 and 5 are perspective views of the construction system, according to various embodiments of the present disclosure; and

FIG. 6 is a flowchart for a method of operating the construction machine.

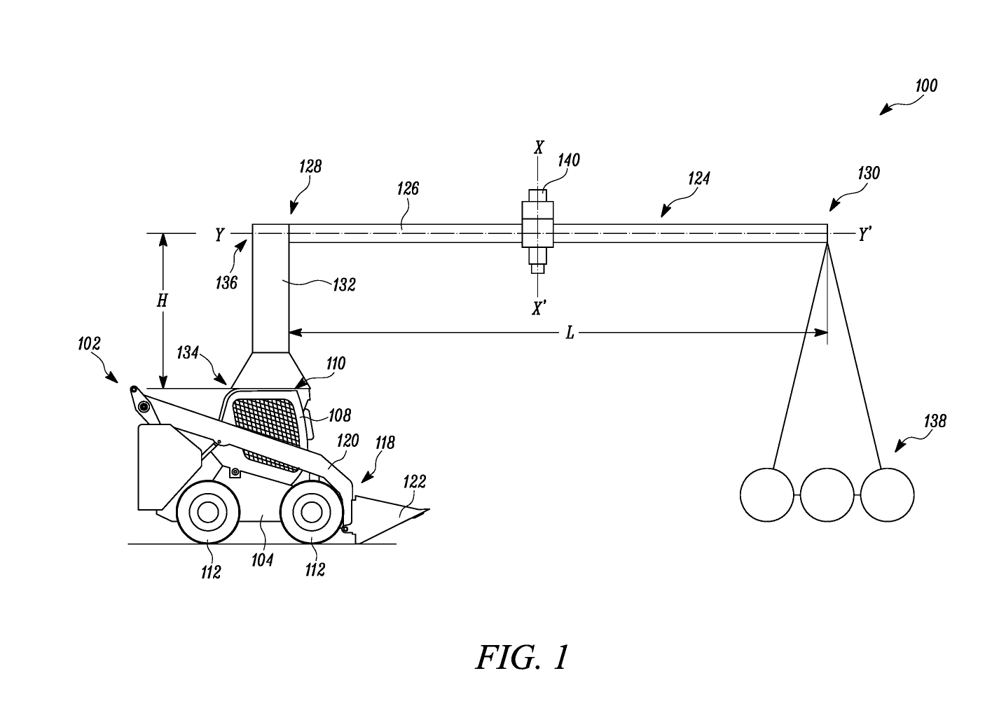

### DETAILED DESCRIPTION

Wherever possible, the same reference numbers will be used throughout the drawings to refer to the same or the like parts. FIG. 1 is a perspective view of an exemplary construction system 100, according to one embodiment of the present disclosure. The construction system 100 includes a machine 102. The machine 102 may include or be part of a mobile vehicle. For example, the machine 102 may include, but is not limited to, track type loaders, multi-terrain loaders, compact track loaders, mining shovels, wheel loaders, back hoe loaders, motor graders, track type tractors, wheeled tractors, pavers, excavators, material handlers, forestry machines, or any other type of machine, mobile or stationary. For simplicity purposes, the machine 102 is shown and described as a skid steer loader.

The machine 102 includes a body 104 having upright stanchions or tower portions (not shown) on a left and right side of the machine 102, and an operator station 108. A roof 110 of the machine 102 is defined on the operator station 108 of the machine 102. Further, the machine 102 includes drive wheels 112 that are mounted to the body 104 and are powered by a power source (not shown), such as an engine. The engine is mounted to the body 104 rearward of the operator station 108 in an engine enclosure (not shown).

The drive wheels 112 are driven in a manner traditionally known in the art. However, in an alternative embodiment, the drive wheels 112 may be replaced by left and right endless belts or track assemblies, or some other type of drive system (not shown). For example, the machine 102 may be embodied as a tracked machine. The machine 102 includes a linkage assembly 118. The linkage assembly 118 includes lift arms 120 pivotably mounted on the left and right side of the body 104. The machine 102 may also include a work implement 122, such as a bucket, pivotally mounted at a front end of the lift arms 120.

The construction system 100 includes a gantry system 124. In one example, the gantry system 124 is a 3D construction gantry system. The gantry system 124 includes a beam member 126. The beam member 126 includes a first end 128 and a second end 130. The first end 128 of the beam member 126 is supported on the machine 102. More particularly, the first end 128 of the beam member 126 may be supported by the linkage assembly 118, the work implement 122, or the roof 110 of the machine 102. In the embodiment illustrated in FIG. 1, the first end 128 of the beam member 126 is supported on the roof 110 of the machine 102.

The gantry system 124 includes a first coupler 132. The first coupler 132 removably couples the first end 128 of the beam member 126 with the roof 110. The first coupler 132 may be embodied as a pillar structure. The first coupler 132 extends along a first axis X-X′. The first coupler 132 is connected with the roof 110 at a bottom end 134 thereof. Further, a top end 136 of the first coupler 132 is coupled with the first end 128 of the beam member 126. In the illustrated embodiment, a height “H” is defined between the roof 110 and a second axis Y-Y′ defined by the beam member 126. In one example, the height “H” may remain fixed during formation of one construction layer at a construction site, and may be changed during formation of a subsequent construction layer. In another example, the first coupler 132 may include a mechanism that allows dynamic adjustment in the height “H” during the formation of a single layer at the construction site. The height “H” may be varied as per operational requirements, for different construction events.

As shown in FIG. 1, the second end 130 of the beam member 126 is supported by an A-frame support 138. The A-frame support 138 may be made of a metal or a non-metal, based on system requirements. A weight of the A-frame support 138 is decided based on a weight and dimensions of the beam member 126. The machine 102 and the A-frame support 138 together support either ends 128, 130 of the beam member 126 so that the beam member 126 remains horizontal in operation. It should be noted that the second end 130 of the beam member 126 may be supported by another support structure apart from the A-frame support 138, without limiting the scope of the present disclosure.

The gantry system 124 includes a dispensing system 140. The dispensing system 140 dispenses construction material during the construction event. The dispensing system 140 is coupled to the beam member 126. The dispensing system 140 is movable along a length “L” of the beam member 126. In one example, the dispensing system 140 is embodied as an extruder. The dispensing system 140 may embody any known system/equipment that allows dispensing of the construction material. For the 3D construction gantry system, the dispensing system 140 may be embodied as a print head.

Further, the dispensing system 140 may be movable along the first axis X-X′ with respect to the beam member 126 of the gantry system 124. More particularly, the dispensing system 140 may be moved about the first axis X-X′ as per requirements for formation of various construction layers. The dispensing system 140 may be powered and operated by a hydraulic system or a pneumatic system of the machine 102. Further, the hydraulic and/or pneumatic system of the machine 102 may also be utilized to move the dispensing system 140 along the first axis X-X′ and along the length “L” of the beam member 126.

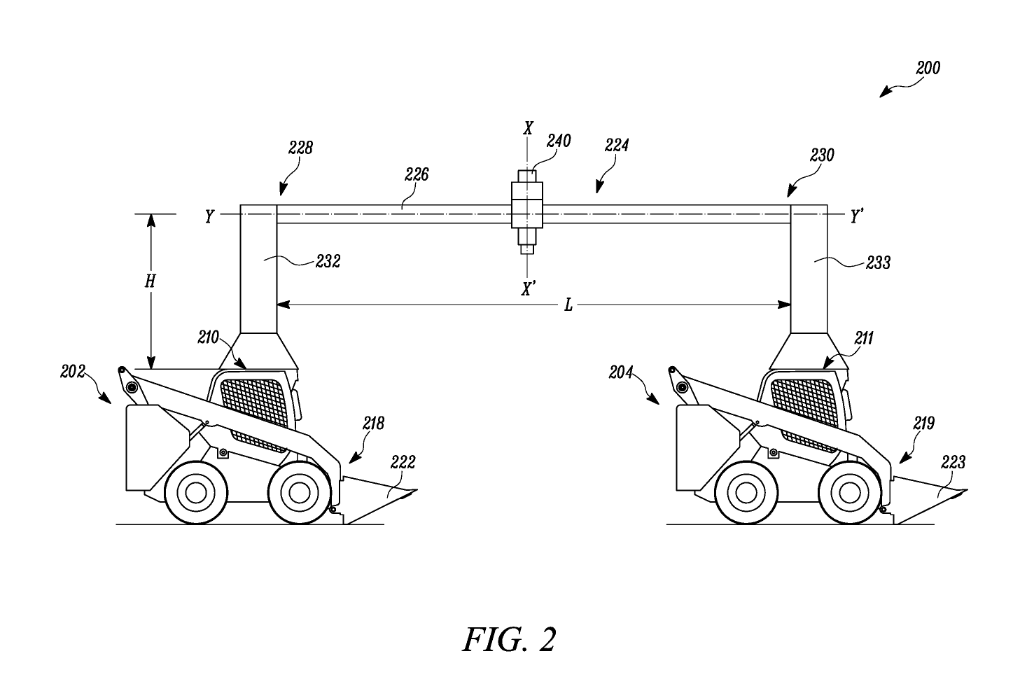

Referring to FIG. 2, the construction system 200 is illustrated, according to another embodiment of the present disclosure. The construction system 200 includes the first machine 202 and a second machine 204. The first machine 202 and the second machine 204 may be similar or different from each other. In one example, the first and second machines 202, 204 may be similar to the machine 102 shown in FIG. 1. Accordingly, the first and second machines 202, 204 may include a skid steer loader. Alternatively, the first and second machines 202, 204 may embody any other wheeled or tracked machine known in the art. Further, the construction system 200 includes the gantry system 224 having the beam member 226 and the dispensing system 240. A design of the beam member 226 and the dispensing system 240 is similar to a design of the beam member 126 and the dispensing system 140 described with reference to FIG. 1.

As shown in the accompanying figures, the first end 228 of the beam member 226 is supported by a portion of the first machine 202 and the second end 230 of the beam member 226 is supported by a portion of the second machine 204. More particularly, the first end 228 is supported by the roof 210 of the first machine 202, whereas the second end 230 is supported by the roof 211 of the second machine 204. In other examples, the first end 228 may be supported by the linkage assembly 218 or the work implement 222 of the first machine 202 and the second end 230 may be supported by the linkage assembly 219 or the work implement 223 of the second machine 204, without any limitations.

The construction system 200 includes the first coupler 232 and a second coupler 233. The first coupler 232 removably couples the roof 210 with the first end 228 of the beam member 226, whereas the second coupler 233 removably couples the roof 211 with the second end 230 of the beam member 226. The first and second couplers 232, 233 may be similar in design to the first coupler 132 described with reference to FIG. 1. Further, for construction purposes, the dispensing system 240 may be moved along the first axis X-X′. In an alternate example, each of the first and second couplers 232, 233 may include a mechanism that allows the beam member 226 to move along the first axis X-X′ during the construction event.

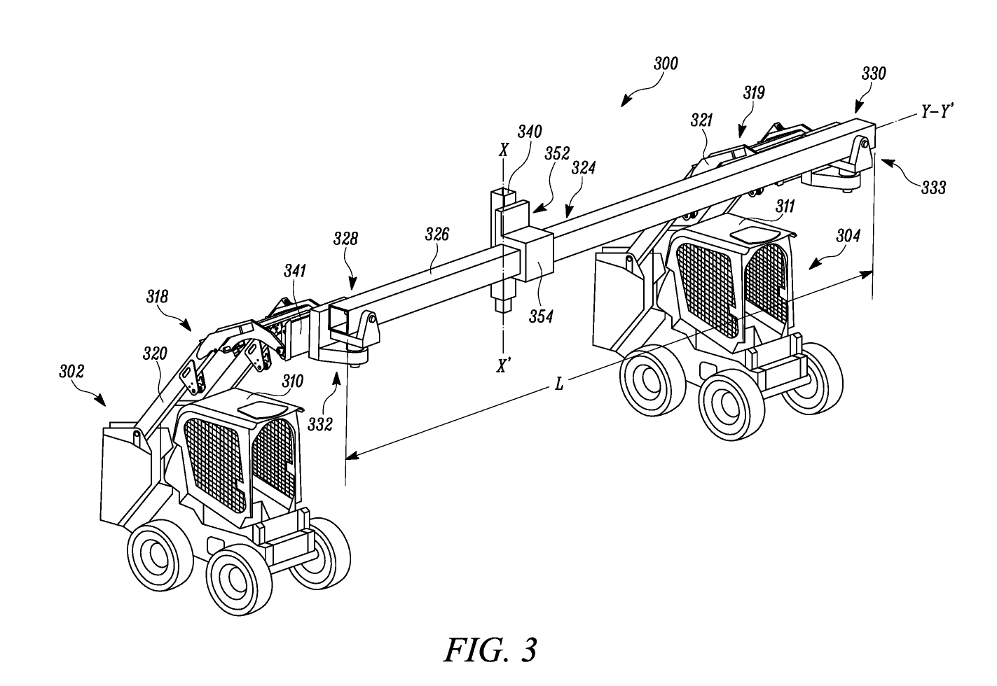

FIG. 3 illustrates yet another embodiment of the construction system 300. The construction system 300 includes the first machine 302 and the second machine 304. In the illustrated embodiment, the first and second machines 302, 304 are embodied as skid steer loaders. Alternatively, the first and second machines 302, 304 may embody any other wheeled or tracked machine known in the art. The first machine 302 and the second machine 304 may be similar or different from each other.

The construction system 300 includes the gantry system 324. The gantry system 324 includes the beam member 326 and the dispensing system 340. The beam member 326 of the gantry system 324 is supported at the first end 328 by the first machine 302. Further, the beam member 326 is supported at the second end 330 by the second machine 304. In the illustrated embodiment, the beam member 326 is supported at either ends by the linkage assembly 318, 319 of the machines 302, 304, respectively. The beam member 326 of the gantry system 324 may be raised to a desired height by controlling hydraulic/pneumatic cylinders of the linkage assemblies 318, 319 of the respective machines 302, 304. More particularly, a personnel can control a movement of the linkage assembly 318, 319 of the respective machines 302, 304 to raise or lower the beam member 326 of the gantry system 324.

In the illustrated embodiment, the first coupler 332 removably couples the first end 328 of the beam member 326 with the lift arms 320 of the linkage assembly 318 of the first machine 302. Further, a second coupler 333 removably couples the second end 330 of the beam member 326 with the lift arms 321 of the linkage assembly 319 of the second machine 304. In another example, the first and second coupler (not shown) may be removably coupled to the work implement or the roof 310, 311 of the first and second machines 302, 304, respectively, without limiting the scope of the present disclosure.

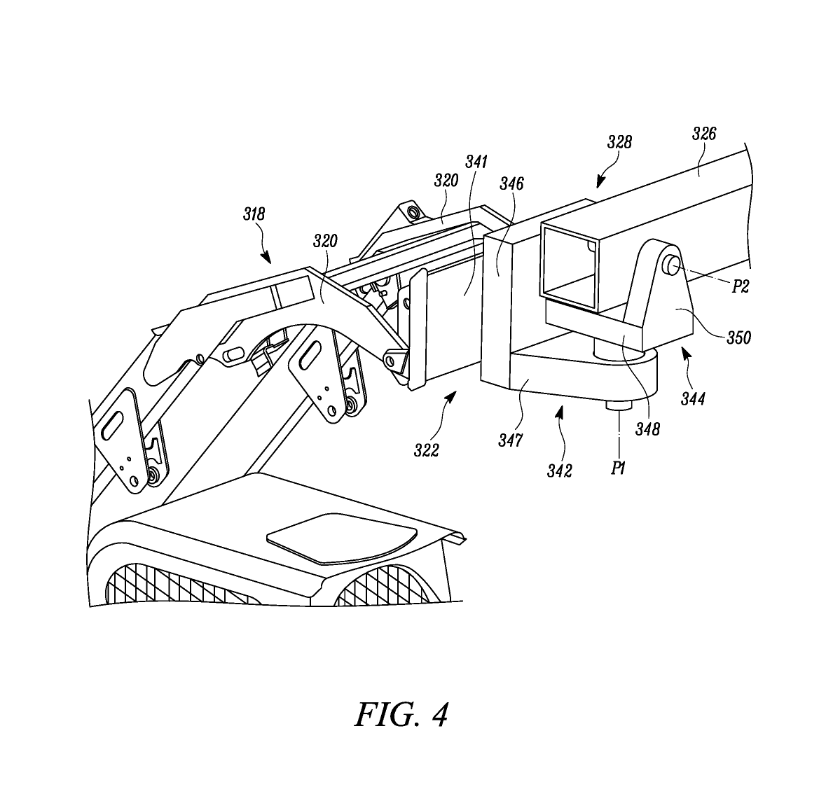

A design of the first coupler 332 will now be explained in detail with reference to FIGS. 3 and 4. It should be noted that the description provided below is equally applicable to the second coupler 333, without limiting the scope of the present disclosure. The first coupler 332 is removably coupled to the linkage assembly 318 of the first machine 302. For example, the first coupler 332 may be coupled with the linkage assembly 318 using mechanical fasteners. Any mechanical fastener such as a bolt, stud, pin, screw, rivet, and the like may be used to couple the first coupler 332 with the linkage assembly 318. Further, the first end 328 of the beam member 326 is coupled to the first coupler 332 by an articulating joint.

Referring to FIG. 4, the first coupler 332 includes a plate member 341. Further, a first bracket member 342 is coupled to the plate member 341. The first bracket member 342 is embodied as an L-shaped bracket. The first bracket member 342 includes a first arm 346 and a second arm 347. The first arm 346 of the first bracket member 342 is coupled to the plate member 341. Further, the first coupler 332 includes a second bracket member 344. The second bracket member 344 is pivotally coupled to the first bracket member 342. The second bracket member 344 is pivotable about a pivot axis “P1”. The pivot connection compensates a difference is position of the first and second machines 302, 304. Further, the difference in position is also compensated via powered hydraulic articulation and correction.

The second bracket member 344 includes a base member 348 and a pair of projecting members 350. The base member 348 pivotally connects the second bracket member 344 with the second arm 347 of the first bracket member 342. Further, the first end 328 of the beam member 326 is received in a space defined by the base member 348 and the pair of projecting members 350. The second bracket member 344 is pivotally coupled to the beam member 326. The beam member 326 is pivotable about a pivot axis “P2”.

Referring to FIG. 3, the gantry system 324 also includes the dispensing system 340. The dispensing system 340 is movable along the length “L” of the beam member 326. The dispensing system 340 is coupled to the beam member 326 by a coupling assembly 352. The coupling assembly 352 includes a bracket 354 and a channel (not shown). The bracket 354 is movably coupled with the beam member 326. Further, the channel that supports the dispensing system 340 is coupled to the bracket 354. The channel along with the dispensing system 340 may be movable or fixed about the first axis X-X′, based on system requirements.

The dispensing system 340 may be powered and operated by the hydraulic system or pneumatic system of the first machine 302 and/or the second machine 304. Further, the hydraulic and/or pneumatic system of the first machine 302 and/or the second machine 304 may also be utilized to move the dispensing system 340 along the length “L” of the beam member 326. Also, a pump (not shown) associated with the dispensing system 340 of the gantry system 324 may be powered by the hydraulic system or pneumatic system of one of the machines 302, 304.

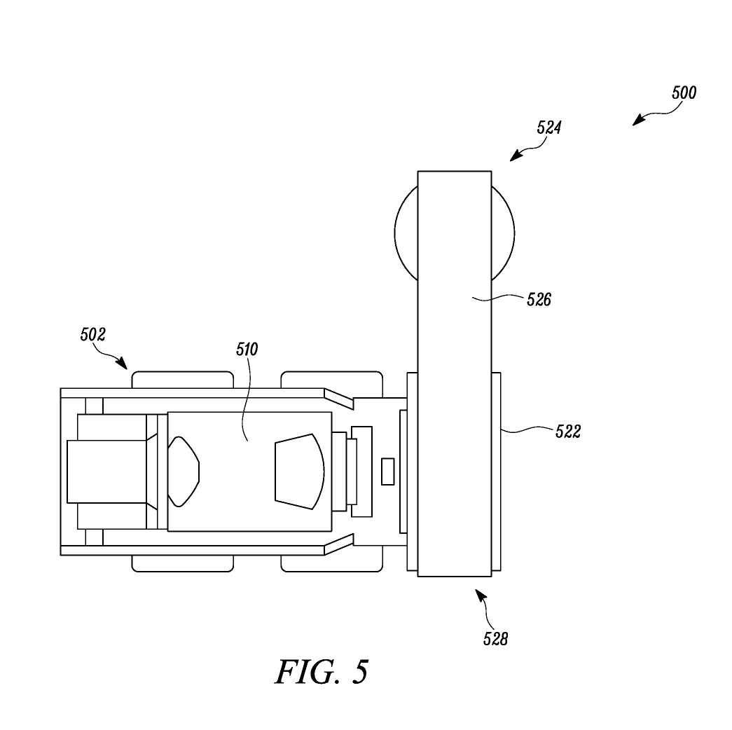

Referring to FIG. 5, a top view of the construction system 500 is illustrated. In this embodiment, the beam member 526 of the gantry system 524 is shorter in length compared to the beam members 226, 326 shown in FIGS. 1, 2, and 3. As the beam member 526 has a shorter length, the beam member 526 is supported at the first end 528. In the illustrated embodiment, the first end 528 of the beam member 526 is supported by the work implement 522 of the machine 502. The beam member 526 includes a coupler (not shown) that couples the first end 528 of the beam member 526 to the work implement 522. In one example, a design of the coupler of the construction system 500 may be similar to the design of the first coupler 332 explained with reference to FIG. 4. Further, in various examples, the first end 528 of the beam member 526 may be supported on the roof 510 or the linkage assembly (not shown) of the machine 502.

### INDUSTRIAL APPLICABILITY

The present disclosure describes the construction system 100, 200, 300, 500 for construction purposes. The construction system 100, 200, 300, 500 provides a simple and cost effective system that ensures reliable support of the gantry system 124, 224, 324, 524. The gantry system 124, 224, 324, 524 of the construction system 100, 200, 300, 500 is easy to set up and use at the construction site. In one example, the construction system 100, 200, 300, 500 disclosed herein can be used for construction of buildings and other structures from unhardened material.

In one example, the beam member 326 of the gantry system 324 may be raised to the desired heights by controlling the linkage assembly 318 of the first machine 302 and/or the second machine 304 (see FIG. 3). Further, the gantry system 324 is coupled to the linkage assembly 318, 319 of the respective machines 302, 304 using the articulating joint (see FIGS. 3 and 4). The articulating joint compensates for ground inaccuracies and when one of the machines is lagging or leading another machine, thereby assuring reliable alignment and balancing.

In another example, instead of adjusting the height “H” of the beam member 126, 226, the dispensing system 140, 240 of the gantry system 124, 224 may be raised or lowered for construction purposes (see FIGS. 1 and 2). Further, in various examples, the construction system 100, 500 may include a single machine (see FIGS. 1 and 5). Thus based on machine availability, the construction system may include a single machine or dual machines.

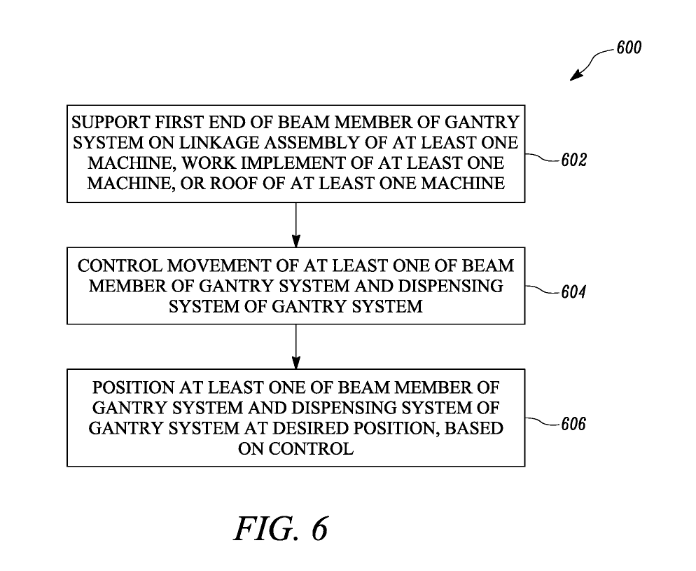

FIG. 6 is a flowchart for a method 600 of operating the construction system 100, 200, 300, 500. For explanatory purposes, the method 600 will now be explained with reference to the construction system 100 shown in FIG. 1. The construction system 100 includes the machine 102 and the gantry system 124. In one example, the gantry system 124 includes the 3D construction gantry system. Further, the machine 102 includes the linkage assembly 118, the work implement 122, and the roof 110. At step 602, the first end 128 of the beam member 126 of the gantry system 124 is supported on the machine 102. The first end 128 may be supported by the work implement 122 of the machine 102, the linkage assembly 118 of the machine 102, or the roof 110 of the machine 102. The first end 128 of the beam member 126 is removably coupled to any one of the linkage assembly 118, the work implement 122, or the roof 110 of the machine 102. Further, the second end 130 of the beam member 126 is supported by the A-frame support 138.

At step 604, the movement of the dispensing system 140 of the gantry system 124 is controlled. The dispensing system 140 of the gantry system 124 is coupled to the beam member 126. The dispensing system 140 is movable along the length “L” of the beam member 126. In one example, the dispensing system 140 is movable along the first axis X-X′ with respect to the beam member 126 of the gantry system 124. In an alternate example, the movement of the beam member 126 of the gantry system 124 may be controlled. At step 606, the dispensing system 140 of the gantry system 124 is positioned at the desired height based on the control. In an alternate example, the beam member 126 of the gantry system 124 is positioned at the desired height based on the control.

According to some embodiments, the beam member 226, 326 may be supported at the first end 228, 328 by the portion of the first machine 202, 302 and at the second end 230, 330 by the portion of the second machine 204, 304. The portion of the first machine 202, 302 and the second machine 204, 304 may include the work implement 222, 223, the linkage assembly 218, 219, 318, 319, or the roof 210, 211, 310, 311.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A construction system comprising:
at least one machine having a linkage assembly, a work implement, and a roof; and
a gantry system having a beam member, wherein the beam member is supported at a first end by the linkage assembly of the at least one machine, the work implement of the at least one machine, or the roof of the at least one machine.

2. The construction system of claim 1, comprising a first coupler configured to removably couple the linkage assembly, the work implement, or the roof with the first end of the beam member.

3. The construction system of claim 2, wherein the first end of the beam member and the first coupler are coupled with an articulating joint.

4. The construction system of claim 1, wherein a second end of the beam member is supported by an A-frame support.

5. The construction system of claim 1, wherein the beam member is supported at the first end by a portion of a first machine and at a second end by a portion of a second machine, wherein the portion of the first and second machines include at least one of a linkage assembly, a work implement, and a roof.

6. The construction system of claim 5, wherein a movement of the beam member is controlled by a linkage assembly of at least one of the first machine and the second machine.

7. The construction system of claim 1, wherein a dispensing system is coupled to the beam member of the gantry system, the dispensing system being movable along a length of the beam member, wherein the dispensing system is operated by a hydraulic system of the at least one machine.

8. The construction system of claim 7, wherein the dispensing system is movable along a first axis with respect to the beam member of the gantry system.

9. The construction system of claim 1, wherein the gantry system is a 3D construction gantry system.

10. A method of operating a construction system having at least one machine and a gantry system, wherein the at least one machine includes a linkage assembly, a work implement, and a roof, the method comprising:
supporting a first end of a beam member of the gantry system on the linkage assembly of the at least one machine, the work implement of the at least one machine, or the roof of the at least one machine;
controlling a movement of at least one of the beam member of the gantry system and a dispensing system of the gantry system; and
positioning at least one of the beam member of the gantry system and the dispensing system of the gantry system at a desired position, based on the control.

11. The method of claim 10 comprising:
coupling, removably, the linkage assembly, the work implement, or the roof with the first end of the beam member by a first coupler.

12. The method of claim 10 comprising:
supporting a second end of the beam member by an A-frame support.

13. The method of claim 10 comprising:
supporting the beam member at the first end by a portion of a first machine and at a second end by a portion of a second machine, wherein the portion of the first and second machines include at least one of a linkage assembly, a work implement, and a roof.

14. The method of claim 10 comprising:
coupling a dispensing system of the gantry system to the beam member, wherein the dispensing system is movable along a length of the beam member; and
operating the dispensing system by a hydraulic system of the at least one machine.

15. The method of claim 14 comprising:
moving the dispensing system along a first axis with respect to the beam member of the gantry system.

16. The method of claim 10, wherein the gantry system is a 3D construction gantry system.

17. A construction system comprising:
at least one machine having a linkage assembly, a work implement, and a roof; and
a gantry system including:
a beam member supported at a first end by the linkage assembly of the at least one machine, the work implement of the at least one machine, or the roof of the at least one machine; and
a dispensing system configured to dispense construction material, the dispensing system being coupled to the beam member of the gantry system and configured to move along a length of the beam member.

18. The construction system of claim 17, wherein a second end of the beam member is supported by an A-frame support.

19. The construction system of claim 17, wherein the beam member is supported at the first end by a portion of a first machine and at a second end by a portion of a second machine, wherein the portion of the first and second machines include at least one of a linkage assembly, a work implement, and a roof.

20. The construction system of claim 17, wherein the dispensing system is movable along a first axis with respect to the beam member of the gantry system.
